(19) United States
(12) Patent Application Publication
(10) Pub. No.: US 2022/0414332 A1
(43) Pub. Date: Dec. 29, 2022

(54) METHOD AND SYSTEM FOR AUTOMATICALLY GENERATING BLANK-SPACE INFERENCE QUESTIONS FOR FOREIGN LANGUAGE SENTENCE

(71) Applicant: LXPER INC., Seoul (KR)

(72) Inventor: Hyung Jong LEE, Seoul (KR)

(73) Assignee: LXPER INC., Seoul (KR)

(21) Appl. No.: 17/767,890

(22) PCT Filed: Sep. 23, 2020
(86) PCT No.: PCT/KR2020/012813

§ 371 Date: Apr. 9, 2022

(30) Foreign Application Priority Data
Oct. 10, 2019 (KR) 10-2019-0125064

(51) Int. Cl. G06F 40/284; G06F 40/205

(52) U.S. Cl. CPC G06F 40/284; G06F 40/205

(57) ABSTRACT

A method for automatically generating blank-space inference questions for a foreign language sentence, according to the present invention, comprises the steps of: receiving one or more foreign language sentence; designating a range to be set as blank spaces among the inputted foreign language sentences; designating setting information for generating a wrong-answer sheet; and generating blank-space inference questions according to the blank range and the setting information by using a sentence generation algorithm based on preset artificial intelligence.

### TECHNICAL FIELD

The present invention relates to a method and system for automatically generating a blank inference question for a foreign language sentence.

### BACKGROUND ART

FIG. 1 is a diagram for illustrating a blank inference question.

The blank inference question is a type proposed in various tests to evaluate foreign language ability, and is a question that asks an examinee to read sentences before and after the blank and then select choice items (example or option) best suitable for the corresponding context.

The blank inference question, for example, in a foreign language area of SAT, is very difficult compared to other question types such as sentence search, long sentence question, summary, sentence arrangement, etc., and requires a lot of practices.

In order to present such blank inference questions, examiners typically select one or more foreign language texts (or sentences) and then designate a specific phrase, clause or sentence as a blank area from the corresponding text (or sentence).

Further, the original text initially written in the designated blank area is set as the correct answer choice, while preparing incorrect answer choices grammatically corrected but not matched the context.

Conventionally, since the examiner had to create incorrect answer choices by themselves, it took a long time to present one blank inference question. Further, there were frequent grammatical errors because such incorrect answer choices are artificially created.

### DISCLOSURE

### Technical Problem

An embodiment of the present invention provides a method and system for automatically creating a blank inference question for a foreign language sentence by generating incorrect answer choices using an artificial intelligence (AI)-based sentence generation algorithm.

However, a technical problem to be overcome by the present embodiment is not limited to the technical problem as described above, and other technical problems may also exist.

### Technical Solution

According to an aspect of the present invention to solve the above problems, a method for automatically creating a blank inference question for a foreign language sentence (“foreign language sentence blank inference question”) may include: inputting one or more foreign language sentences; designating a range to be set as a blank among the input foreign language sentences; designating setting information for generation of incorrect answer choices; and creating a blank inference question according to the blank range and the setting information using a preset artificial intelligence (AI)-based sentence generation algorithm.

According to another aspect of the present invention to solve the above problems, a system for automatically creating a foreign language blank inference question may include: a communication module that receives one or more foreign language sentences inputted by a user and receives setting information for generation of incorrect answer choices as well as a range to be set as a blank among the input foreign language sentences; a memory in which a computer program for creating a blank inference question for the foreign language sentences received from the communication module is stored; and a processor that creates the blank inference question according to the blank range and the setting information using a preset artificial intelligence (AI)-based sentence generation algorithm as the computer program stored in the memory is executed.

Other specific details of the present invention are included in the detailed description and drawings.

### Advantageous Effects

According to any one of the above-described technical solutions of the present invention, even if a random part of the input foreign language texts (or sentences) is designated as a blank, there an advantage that a number of incorrect answer choice can be automatically generated while taking into account the front and rear contexts.

Further, it possible to automatically generate an incorrect answer choice that is grammatically correct but is not correct in ems of context by estimating a degree contextual similarity with the correct answer.

In addition, a user can set a desire difficulty level in vocabulary, and the frequency of appearance of words exceeding the difficulty level may be controlled through various methods in consideration of the set difficulty level.

Effects of the present invention are not particularly limited to the effects mentioned above, instead, other effects would be clearly understood by those skilled in the art from the following description.

### DESCRIPTION OF DRAWINGS

FIG. 1 is a diagram illustrating a blank inference question.

FIG. 2 is a flowchart showing a method for automatically creating a foreign language sentence blank inference question according to an embodiment of the present invention.

FIGS. 3a to 3c are diagrams illustrating a use example of the present invention.

FIGS. 4a to 4e are diagrams illustrating a process of generating multiple incorrect answer candidate choices in a first embodiment of the present invention.

FIGS. 5a to 5g are diagrams illustrating a process of generating multiple incorrect answer candidate choices in a second embodiment of the present invention.

FIGS. 6a and 6b are diagrams illustrating a process of generating multiple final incorrect answer candidate choices in the first and second embodiments of the present invention, respectively.

FIGS. 7a and 7b are diagrams illustrating a process of generating multiple incorrect answer choices according to an embodiment of the present invention.

FIGS. 8a and 8b are diagrams illustrating a method for setting a difficulty level according to an embodiment of the present invention.

FIG. 9 is a diagram illustrating a system for automatically creating a foreign language sentence blank inference question according to an embodiment of the present invention.

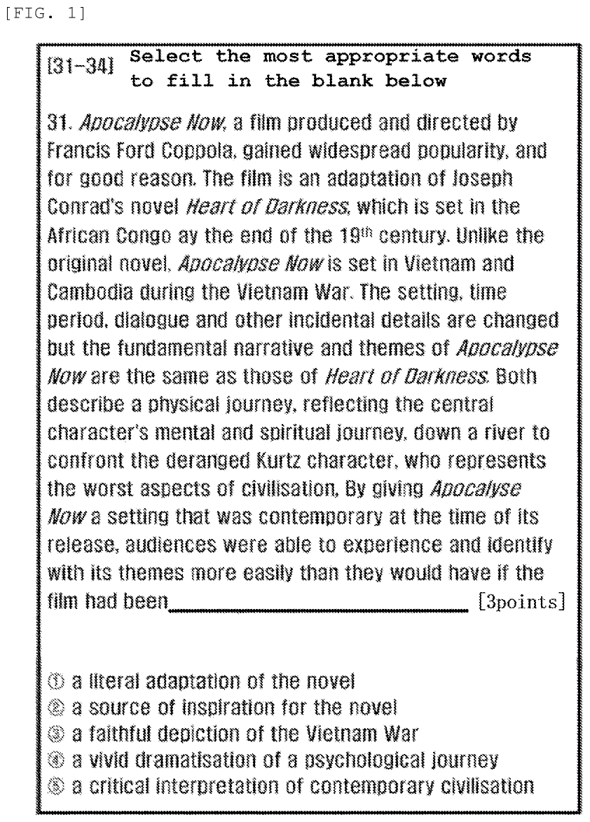

### DETAILED DESCRIPTION OF PREFERRED EMBODIMENTS OF INVENTION

Advantages and features of the present invention, and a method of achieving the same will be become apparent with reference to the embodiments described below in detail together with the accompanying drawings. However, the present invention is not limited to the embodiments disclose below, but may be implemented in a variety of different forms. Therefore, the present embodiments are only provided to fully inform those skilled in the art of the scope of the present invention, and the present invention is only defined by the scope of the appended claims.

The terms used in the present specification are for describing exemplary embodiments and are not intended to limit the present invention. In the present specification, the singular expression may include a plural expression unless specifically stated in the phrase. As used herein, the terms “comprises” and/or “comprising” do not exclude the presence or addition of one or more further elements other than the mentioned elements. Throughout the specification, the same reference numerals refer to the same elements, and “and/or” includes each and all combinations of one or more of the mentioned elements. Although “first”, “second” and the like are used to describe various elements, these elements are of course not limited by the above terms. These terms are only used to distinguish one component from another component. Therefore, it would be of course understood that the first component mentioned below may be the second component within the technical idea of the present invention.

Unless otherwise defined, all terms (including technical and scientific terms) used in the present specification may be used with meanings that are commonly understood by those skilled in the art to which the present invention pertains. In addition, terms defined in the commonly used dictionary are not interpreted ideally or excessively unless defined explicitly and specifically.

Hereinafter, embodiments of the present invention will be described in detail with reference to the accompanying drawings.

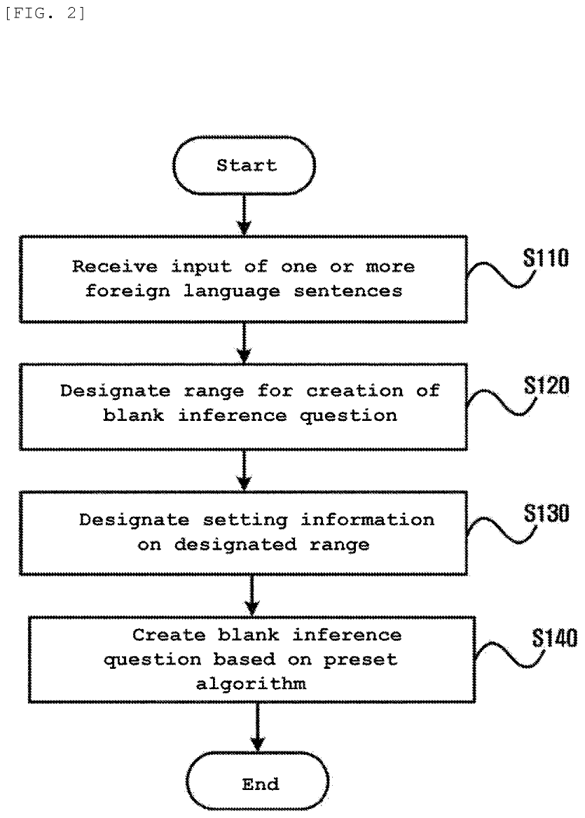

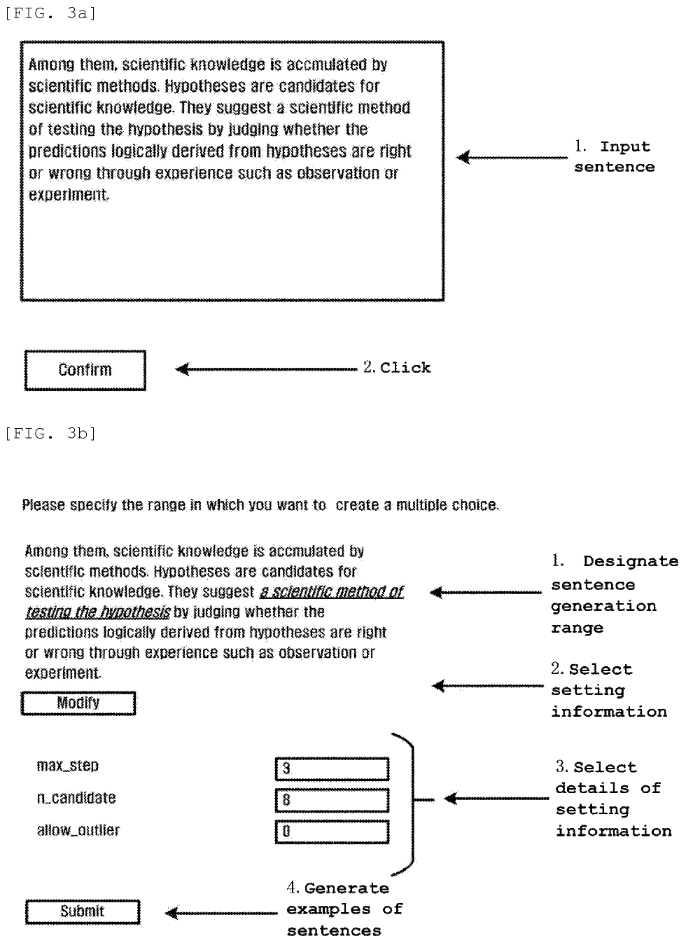

FIG. 2 is a flowchart showing a method for automatically creating a foreign language sentence blank inference question according to an embodiment of the present invention. FIGS. 3a to 3c are diagrams illustrating a use example of the present invention.

Meanwhile, the steps shown in FIG. 2 may be understood as being performed by a server of a platform or company that provides a foreign language sentence blank inference question creation service (hereinafter, referred to as a “server”), but is not limited thereto.

In an embodiment of the present invention, the foreign language is not limited to English shown in the drawings, but any foreign language other than the native language such as Japanese, Chinese, etc. may become a target. Further, one embodiment of the present invention does not exclude Korean, therefore, in the case of targeting foreigners, Korean may be of course applied as a foreign language.

According to an embodiment of the present invention, first, a server may receive a text composed of one or more foreign language sentences inputted by a user (S110).

Referring to FIG. 3a as an embodiment, a user accesses a web page that provides a service, and firstly inputs one or more foreign language sentences so as to create a blank inference question.

Further, when the user clicks an input button, the corresponding content is transmitted to the server.

Next, the server receives designation of a range to be set (“setting range”) as a blank among the input foreign language sentences (S120), and then designation of setting information for generating an incorrect answer choice (S130).

Referring to FIG. 3b as an embodiment, a user may designate a setting range as a blank among the input foreign language sentences and also designate setting information on how and what method to generate an incorrect answer choice.

For example, the setting information able to be designated by the user may include parameters in relation to how many times to repeat the sentence generation process described later, how many incorrect answer candidates would be prepared, and whether unnatural sentences due to grammatical errors would be included in the incorrect answer candidates, or the like, but is not limited thereto.

According to an embodiment of the present invention, incorrect answer choices may be generated as various results of combining some of setting information.

Meanwhile, the user may input a foreign language sentence or designate the setting range and the setting information through a user's terminal. Herein, the user's terminal may include a telecommunication device or a computer device such as a smart phone, tablet, PDA, laptop, desktop, server, or the like.

Next, the server may use a preset artificial intelligence (AI)-based sentence generation algorithm to create a blank inference question according to the blank range and the setting information (S140).

The server may set the designated range as a blank among the input foreign language sentences, generate the original text in the designated range as a correct answer choice, and then, generate multiple incorrect answer choices through the preset AI-based sentence generation algorithm on the basis of the correct answer choice.

An example of the bank inference question created as described above is shown in FIG. 3c.

The server may display and output the range designated by the user with respect to the foreign language sentences inputted by the user.

Further, the incorrect answer choices generated according to the designated range and the setting information may be output along with the correct answer choice.

At this time, the user may set an output mode of the server by designating some parameters. For example, the user may designate whether to display a metric of the generated sentence, but is not limited thereto.

Alternatively, according to an embodiment of the present invention, a foreign language sentence inputted for application of the preset AI-based sentence generation algorithm may be divided into word-based tokens to be used.

Further, using the divided tokens, it is possible to choose how to generate an incorrect answer choice with respect to a blank inference question.

In this case, when generating multiple incorrect answer choices, the server may generate an incorrect answer choice consisting of the number of tokens having a length equal to or different from the range designated by the user.

Alternatively, it may be generated to include one or more incorrect answer choices among an incorrect answer choice having a preset similarity range to the correct answer choice and an incorrect answer choice outside the preset similarity range to the correct answer choice.

Of course, these methods may be applied in combination with each other.

For example, the server may generate an incorrect answer choice in a context structure that has the same token length as the range designated by the user, and has the highest similarity to the correct answer. In the case of a first embodiment, the length of the generated token may be the same as the correct answer, the context structure may be similar to the correct answer while having a low possibility of grammatical errors, however, the diversity of vocabulary may be somewhat low.

On the contrary, the server may have a token length that is different from the range designated by the user, and may generate an incorrect answer choice having a context structure out of a predetermined range of similarity to the correct answer. In the case of a second embodiment, the length of the generated token may be identical to or different from the correct answer, and the context structure may have a low similarity to the correct answer and a little high possibility of grammatical errors, however, the diversity of vocabulary may become high.

As described above, an embodiment of the present invention has an advantage of generating incorrect answer choices by mutually combining various methods such that, for example, if a (foreign language) level of students is high, incorrect answer choices very similar to the correct answer are presented, while generating incorrect answer choices not similar to the correct answer if the level of students is somewhat low.

On the other hand, in an embodiment of the present invention, an incorrect answer choice may be generated using a masked language model (MLM)-based bidirectional encoder representation from transformers (BERT) algorithm, but is not limited thereto. The BERT algorithm is a two-way deep learning model, which refers to a pre-trained deep learning model that conducts masking a specific clause (word) in a given sentence and then matches the same (Jacob Devlin, Ming-Wei Chang, Kenton Lee, Kristina Toutanova, “BERT: Bidirectional Encoder Representations from Transformers”, 2019).

For example, the BERT algorithm is trained to mask the words “store” and “gallon” in the sentence “the man went to the [MASK] (store) to buy a [MASK] (gallon) of milk”, respectively, and then match the same.

However, with regard to the foreign language sentence blank inference question for the purpose of the present invention, in the case of objective choice, multiple choices (usually four (4) excluding the correct answer in the case of a five-point multiple-choice type) should be prepared rather than only one optimal sentence, while necessarily having low similarity between the generated choices.

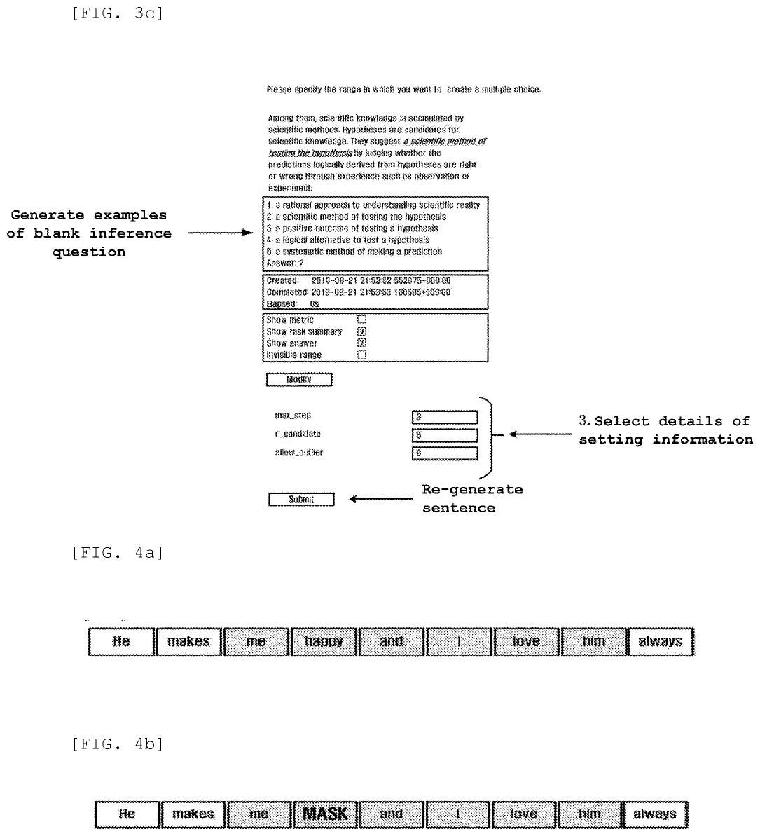

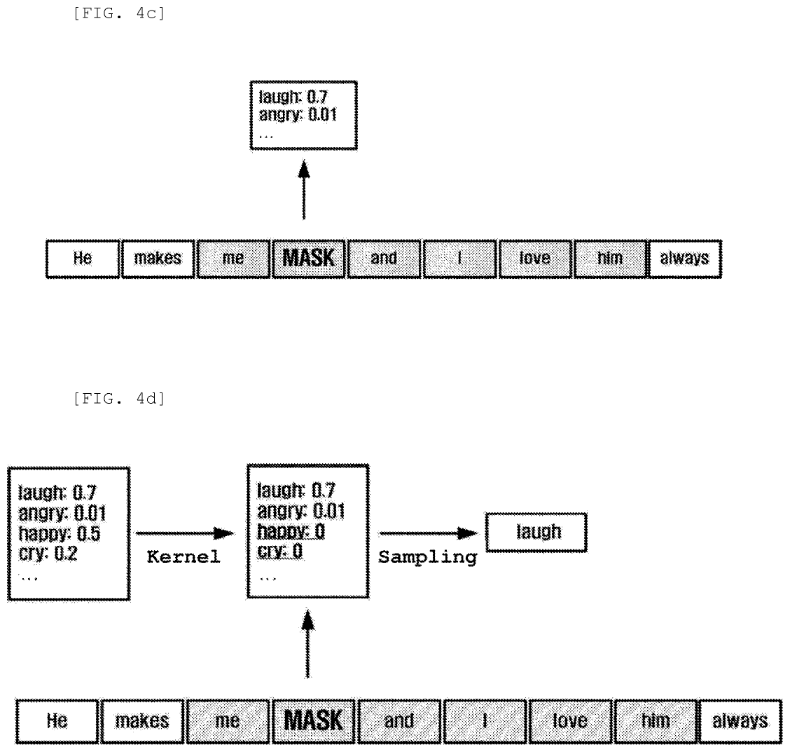

For this reason, an exemplary embodiment of the present inventions may adopt an improved method without using the existing BERT algorithm as it is. Hereinafter, a process of generating multiple incorrect answer choices will be described with reference to FIGS. 4a to 7b.

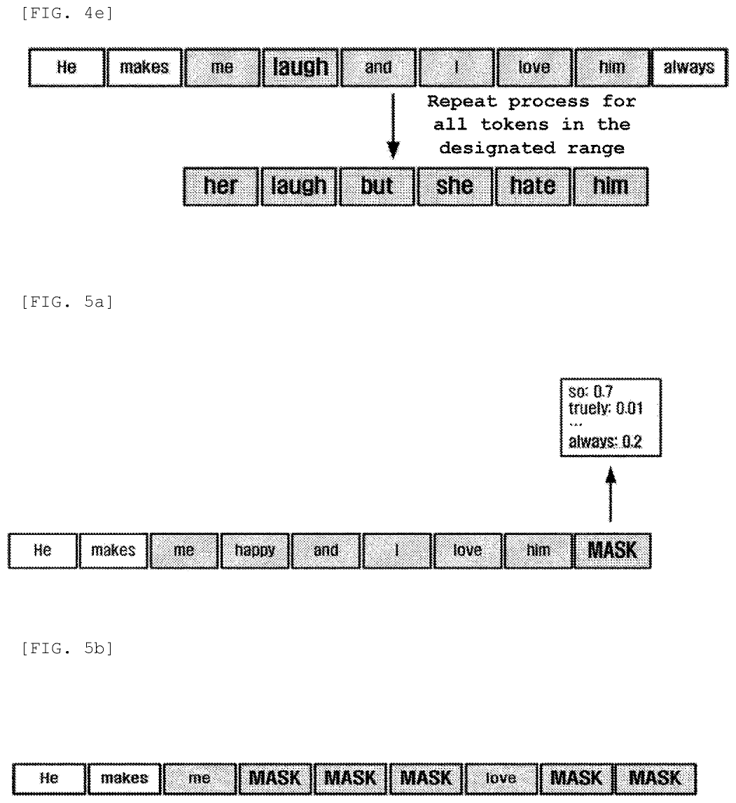

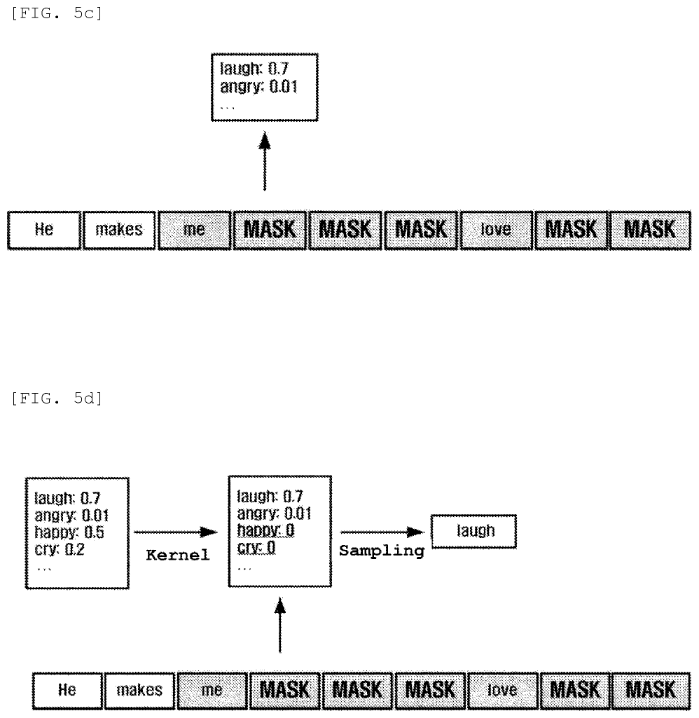

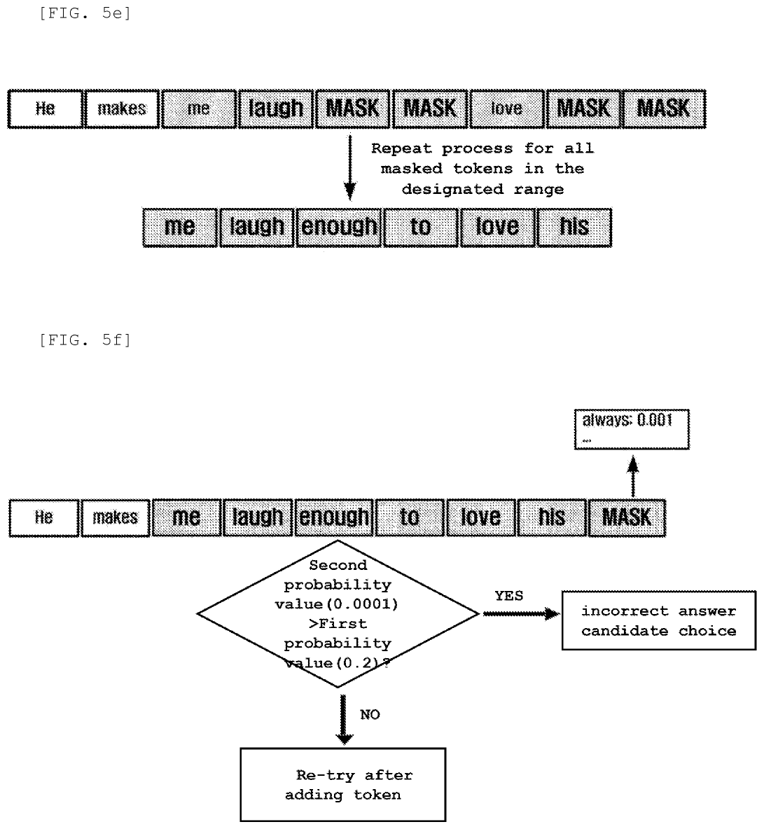

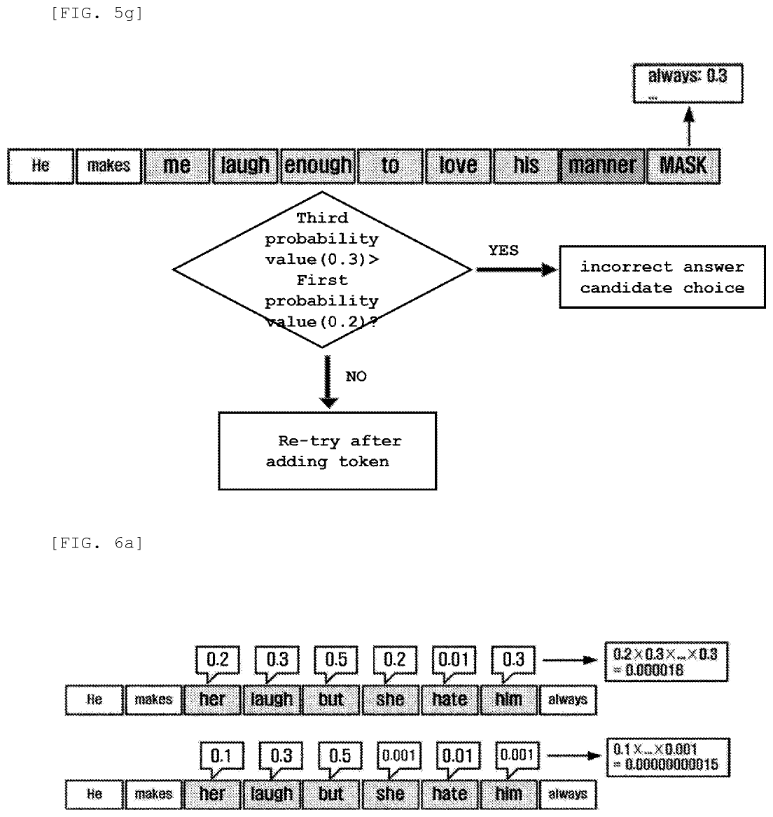

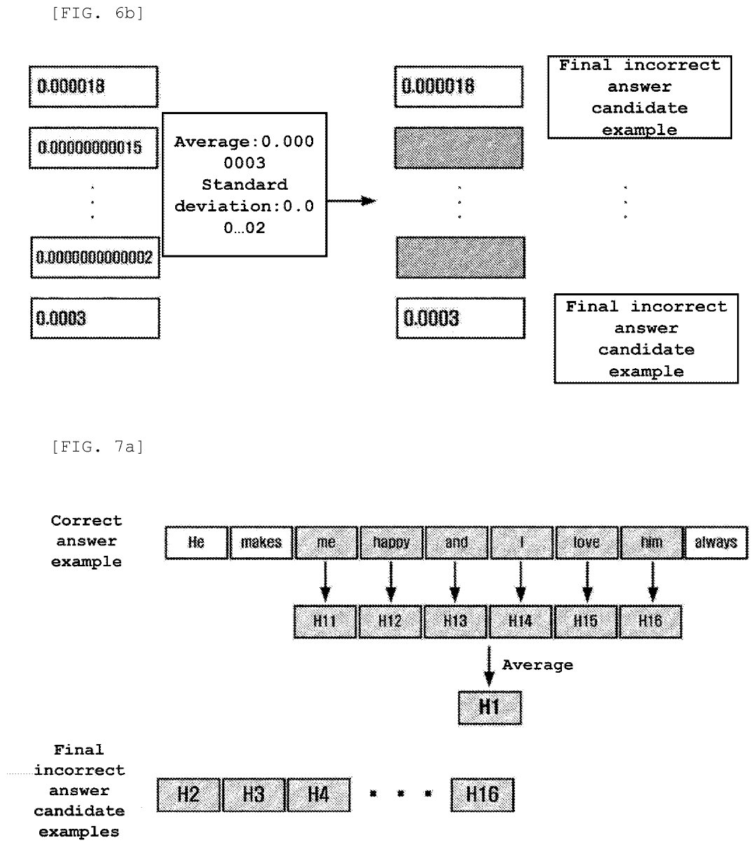

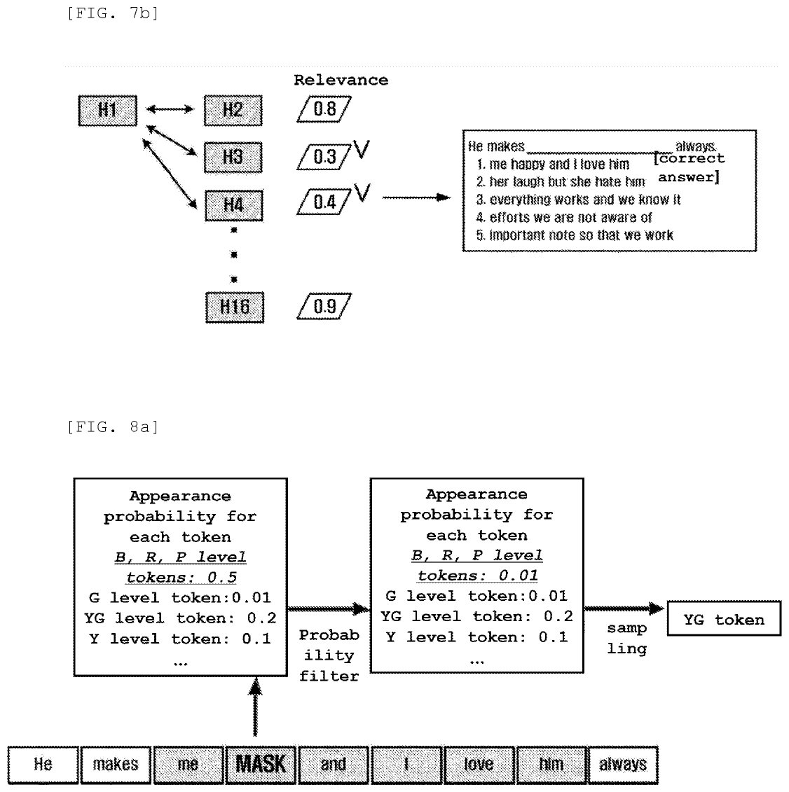

FIGS. 4a to 4c are diagrams illustrating a process of generating multiple incorrect answer candidate choices in the first embodiment of the present invention. FIGS. 5a to 5g are diagrams illustrating multiple incorrect answer candidate choices in the second embodiment of the present invention. FIGS. 6a and 6b are diagrams illustrating a process of generating multiple final incorrect answer candidate choices in the first and second embodiments of the present invention, respectively. Further, FIGS. 7a and 7b are diagrams illustrating a process of generating multiple incorrect answer choices according to an embodiment of the present invention.

According to the first embodiment of the present invention, in order to generate multiple incorrect answer candidate choices, as shown in FIG. 4a, the input foreign language sentence is first divided into word-based tokens, and the range designated by the user is checked.

In the example of FIG. 4a, it could be confirmed that the sentence “He makes me happy and I love him always” including the range designated by the user was changed into the tokens such as “He/makes/me/happy/and/I/love/him/always”, respectively, and that the range designated by the user is “me/happy/and/I/love/him”.

Next, referring to FIG. 4b, a token is randomly selected in the designated range and the randomly selected token is masked. In the example of FIG. 4b, the word “happy” positioned in a second token was masked.

Then, referring to FIG. 4c, a plurality of replaceable words for the masked token position may be predicted on the basis of a probability value.

In other words, a replaceable word at a position of the token covered with a mask may be predicted. At this time, an embodiment of the present invention may deuce a probability value of possible replacement for each word using a BERT algorithm.

For example, the replaceable words may be “laugh” and “angry”, wherein “laugh” is replaceable with the word “happy” at a probability value of 0.7, while “angry” is replaceable with the word “happy” at a probability value of 0.01, that is, indicating very little possibility of replacement.

For example, if the BERT algorithm is used as it is, “laugh” with the highest probability value will be output as the answer of the masked portion. Even in this case, a new word different from the original word “happy” while having no grammatical error will be generated. As such, an embodiment of the present invention uses the BERT algorithm for the purpose of replacing a token selected according to the above-mentioned probability value with another word.

Next, referring to FIG. 4d, the words pass through a kernel that forcibly sets a probability value for words at a predetermined ratio of 0 among a plurality of predicted words. The words whose probability value is forcibly set to 0 may be randomly determined.

According to an embodiment of the present invention, it is possible to prevent repetitive deduction of the same word by passing words through a kernel when an incorrect answer choice is generated.

For example, the server may randomly set a probability value for a word at a predetermined ratio (10%) to 0 and, in the example of FIG. 4d, it could be seen that the probability values of the words “happy” and “cry” were set to be altered from 0.5 and 0.2 to 0, respectively, after passing through the kernel.

Further, the server may conduct sampling of the words that passed through the kernel, thereby extracting one word based on the probability value.

In the example of FIG. 4d, it could be seen that “laugh” is extracted as a result of sampling. In this example, the words “laugh” and “angry” having passed through the kernel may be sampled depending upon each probability value. That is, during sampling, it is highly possible that the word “laugh” is extracted with a probability of 70%, but the word “angry” may be of course extracted.

As described above, an embodiment of the present invention may implement sampling based on a probability value for a plurality of words, and therefore, may impart randomness to incorrect answer choices to be generated. That is, when repeating the generation of incorrect answer choice, the probability value of “laugh” and “happy” may be set to 0 by passing through the kernel in the next time. And, based on the probability value, the word “cry” may be sampled and extracted.

Next, referring to FIG. 4e, the server generates an incorrect answer candidate choice in a demasking process, that is, by inserting the extracted word into the masked position.

At this time, in order to completely generate one incorrect answer candidate choice, the above processes illustrated in FIGS. 4a to 4c including the masking, probability value estimation, extraction (kernel applying and sampling) and demasking steps must be performed repeatedly.

In other words, after performing even the first demasking process, only the word “laugh” may be replaced with respect to the original sentence “He makes me happy and I love him always”. Thereafter, when other tokens are subjected to the above processes, an incorrect answer candidate choice of “He makes her laugh but she hate him always” is finally generated.

According to such a method as described above, the incorrect answer candidate choice may be generated, and the above processes may be repeatedly conducted until a predetermined number of incorrect answer candidate choices corresponding to the setting information are generated.

Next, a second embodiment of the present invention will be described with reference to FIGS. 5a to 5g. In this case, the second embodiment of the present invention is characterized in that a length of the generated incorrect answer candidate choice is not limited to the designated range, but the length of the designated range may be altered by adding tokens.

According to the second embodiment of the present invention, in order to generate multiple incorrect answer candidate choices, as shown in FIG. 5a, the input foreign language sentient is firstly divided into word-based tokens and the range designated by the user is checked.

In the example of FIG. 5a, it could be confirmed that the sentence “He make me happy and I love him always” including the range designated by the user is changed into tokens such as “He/makes/me/happy/and/I/love/him/always”, respectively, and that the range designated by the user is “me/happy/and/I/love/him”.

Furthermore, before masking of the tokens included in the designated range, the masking is firstly conducted on the position of a first token connected to the designated range. Then, a first probability value at the masked corresponding position of the first token is estimated.

In other words, in the example of FIG. 5a, the first token “always” immediately following the designated range is subjected to masking, and the first probability value that the word “always” in the original text appears at the masked corresponding position is recorded.

Accordingly, at the masked corresponding position, “so” may appear with a probability value of 0.7, “truly” may appear with a probability value of 0.01, and “always” as the token word in the original text may appear with a probability value of 0.2. Therefore, the probability value of 0.2 for the token word “always” is recorded as the first probability value.

As will be described later, according to the second embodiment of the present invention, even though the length of the designated range is variable, if the word immediately following the changed range is the same token as the original text, that is, when “always” which is the token in the example can be positioned, this may be regarded as a text to be naturally connected.

Next, referring to FIG. 5b, the server selects some tokens from the designated range and masks the randomly selected tokens. In the example of FIG. 5b, 75% of the tokens in the designated range are masked and, as described above, the position of the first token immediately following the designated range is also masked.

As a result of the above masking process, it could be seen from FIG. 5b that the remaining tokens except for the words “me” and “love” among the designated range such as “He/makes/me/ [MASK]/[MASK]/[MASK]/love/ [MASK]/[MASK]” have been masked, while the position of the token “always” was also masked.

Then, referring to FIG. 5c, the server predicts a plurality of replaceable words at the positions of the masked tokens based on probability values.

In other words, a replaceable word at the position of the masked token may be predicted. At this time, the second embodiment of the present invention may also deduce a probability value of possible replacement for each word through the above BERT algorithm.

For example, the replaceable words such as “laugh” and “angry” may be proposed, wherein “laugh” can replace the word “happy” at a probability value of 0.7, while “angry” can replace the word “happy” at a probability value of 0.01, that is, indicating very little possibility of replacement.

Next, referring to FIG. 5d, the server passes the words through a kernel that forcibly sets a probability value for words at predetermined ratio to 0 among a plurality of predicted words. At this time, the words whose probability value is forcibly set to 0 may be randomly determined.

According to the second embodiment of the present invention, it is possible to prevent repetitive deduction of the same word by passing words through a kernel when an incorrect answer choice is generated.

For example, the server may randomly set a probability value for a word at a predetermined ratio (10%) to 0 and, in the example of FIG. 5d, it could be seen that the probability values of the words “happy” and “cry” were set to be altered from 0.5 and 0.2 to 0, respectively, after passing through the kernel.

Further, the server may conduct sampling of the words that have passed through the kernel, thereby extracting one word based on the probability value.

In the example of FIG. 5d, it could be seen that “laugh” is extracted as a result of sampling. In this example, the words “laugh” and “angry” having passed through the kernel may be sampled depending upon each probability value. That is, during sampling, it is highly possible that the word “laugh” is extracted with a probability of 70%, but the word “angry” may be of course extracted.

As described above, an embodiment of the present invention may implement sampling based on a probability value for a plurality of words, and therefore, may impart randomness to incorrect answer choices to be generated. That is, when repeating the generation of incorrect answer choice, the probability value of “laugh” and “happy” may be set to 0 by passing through the kernel in the next time. And, based on the probability value, the word “cry” may be sampled and extracted.

Next, referring to FIG. 5e, the server inserts the extracted word into the masked position, that is, in a demasking process.

At this time, in the second embodiment, the processes including the probability value estimation, extraction (kernel applying and sampling) and demasking steps must be performed repeatedly for all masked tokens in the range designated by the user.

In other words, after performing even the first demasking process, only the word “laugh” may be replaced in the original sentence “He makes me [MASK] [MASK] [MASK] love [MASK] [MASK]”. Thereafter, when other tokens are subjected to the above processes, a sentence “He makes me laugh enough to love his [MASK]” is generated.

Next, referring to FIGS. 5f and 5g, after inserting the extracted token into the masked position within the designated range, the server estimates a second probability value for the corresponding position continuous with the designated range, that is, the “always” token position in FIG. 5a.

Further, an incorrect answer candidate choice may be generated based on the above described first probability value and the second probability value.

Specifically, when the newly estimated second probability value exceeds the first probability value, an incorrect answer candidate choice may be generated for only the designated range including tokens each inserted at the masked position.

On the contrary, if the second probability value is less than or equal to the first probability value, a masked token between the last token in the designated range and the corresponding position continuous with the designated range is newly added, followed by extracting a single token based on the probability value for the masked token at the newly added position.

Further, after inserting the extracted token into the added position, the server estimates a third probability value for the extracted token at the corresponding position, compares the first and second probability values as described above to thus generate the incorrect answer candidate choice.

For example, according to the algorithm, as shown in FIG. 5g, the server may estimate a second probability value of 0.001, at which “always” appears after “this” positioned at the end of the designated range. In this case, since the newly estimated second probability value (0.001) does not exceed the first probability value (0.2), the server cannot determine the incorrect answer candidate choice with only the designated range.

Accordingly, as shown in FIG. 5g, the server newly adds a masked token between the word “his”, which is the last token position of the designated range, and the token where “always” in the original text, which is a corresponding position continuous with the designated range, is positioned, followed by performing again the above processes including the prediction, kernel application, sampling, extraction and demasking steps again for the newly added masked token.

As a result, a new word “manner” is determined for the masked token and, in this state, the server checks again the third probability value that the word “always” appears after the word “manner”. As a result of confirmation, since the third probability value (0.3) exceeds the first probability value (0.001), the designated range may be changed to include the newly added word “manner”, thereby being generated as an incorrect answer candidate choice.

If the third probability value is less than or equal to the first probability value, the above processes may be further repeatedly conducted to extend the designated range.

Through this method, an incorrect answer candidate choice may be generated, and the processes according to FIGS. 5a to 5g may also repeatedly conducted until a predetermined number of incorrect answer candidate choices according to the setting information are generated.

When a sufficient number of incorrect answer candidate choices are generated according to the first or second embodiment, a process of determining final incorrect answer candidate choices should be implemented.

Referring to FIG. 6a, first, the server estimates an appearance probability value for each of multiple incorrect answer candidate choices with respect to replacement of a blank. That is, an appearance probability value (more precisely, possibility or likelihood) for replacing the original text with each of several incorrect answer candidate choices may be calculated.

In this case, according to an embodiment of the present invention, a mean log-likelihood value for tokens within a predetermined range may be calculated as the appearance probability value, but the present invention is not limited thereto. At this time, log is used to convert multiplication into sum.

In the example of FIG. 6a, for the first sentence “He makes her laugh but she hate him always”, appearance probability values for tokens are estimated such as “her” 0.2, “laugh” 0.3, “but” 0.5, “she” 0.2, “hate” 0.01 and “him” 0.3 and, finally, the appearance probability value of the above sentence may be calculated as 0.000018 which is a multiplication value of the above estimated values.

Likewise, for the second sentence “He makes true love but true have love always”, appearance probability values for tokens are estimated such as “true” 0.1, “love” 0.3, “but” 0.5, “true” 0.001, “hate” 0.01 and “love” 0.001 and, finally, the appearance probability value of the above sentence may be calculated as 0.0000000015 which is a multiplication value of the above estimated values.

Next, referring to FIG. 6b, the server calculates an average of the appearance probability values in the incorrect answer candidate choices, removes the incorrect answer candidate choices out of a preset standard deviation range from the calculated average, and thus determines a final incorrect answer candidate choice. That is, the incorrect answer candidate choice corresponding to the outlier is removed.

This process is to select only the incorrect answer candidate choices with no grammatical errors. Finally, as described later, the incorrect answer candidate choice, which has little relevance to the correct answer and thus is rarely misunderstood as the correct answer, may be selected as a final incorrect answer choice.

After multiple final incorrect answer candidate choices are generated according to the processed shown in FIGS. 6a and 6b, the final incorrect answer choices (for examples, 4 choices) with low relevance to the correct answer should be selected from the above candidates.

To this end, an embodiment of the present invention first calculates a hidden state vector for the correct answer, and also calculates a hidden state vector for the final incorrect answer candidate choices. The calculation of the hidden state vectors is performed in a manner defined in the BERT algorithm.

In other words, as shown in FIG. 7a, a hidden state vector for the correct answer may be calculated by generating a hidden state vector for each token included in the correct answer and then averaging the generated hidden state vectors for the tokens.

For example, for the correct answer divided into tokens of “He/makes/me/happy/and/I/love/him/always”, the server generates hidden state vectors H11 to H16 for tokens with respect to the designated range, that is, “me/happy/and/I/love/him”, followed by averaging the same so as to calculate a hidden state vector H1 for the correct answer.

Similarly, by generating a hidden state vector for each token included in the final incorrect answer candidate choices and averaging the generated hidden state vectors for the tokens, the hidden state vectors (H2 to H16) for the final incorrect answer candidate choices could be calculated (for example, if there are 16 final incorrect answer candidate choices).

Herein, the hidden state vector for each token may include semantic information of each token.

Next, referring to FIG. 7b, the server calculates the relevance between the hidden state vector for the correct answer choice and the hidden state vectors for final incorrect answer candidates, respectively, and thus may select the final incorrect answer candidate choices in the order of the lowest calculated relevance as multiple incorrect answer choices.

For example, a degree of relevance may be calculated by comparing the hidden state vector H1 for the correct answer choice with the hidden state vectors H2 to H16 for the final incorrect answer candidate choices, respectively, and among the above vectors, H3 and H4 calculated with the lowest degree of relevance may be selected as multiple final incorrect answer choices.

At this time, the degree of relevance may be calculated based on cosine-similarity between the hidden state vectors, but is not limited thereto.

According to these processes, as shown in the example of FIG. 7b, a total of 5 choices including one (1) correct answer choice and four (4) incorrect answer choices may be generated.

Meanwhile, an embodiment of the present invention may designate a range in which a blank inference question is created by the user, and may additionally designate a difficulty level with respect to designation of setting information for the designated range.

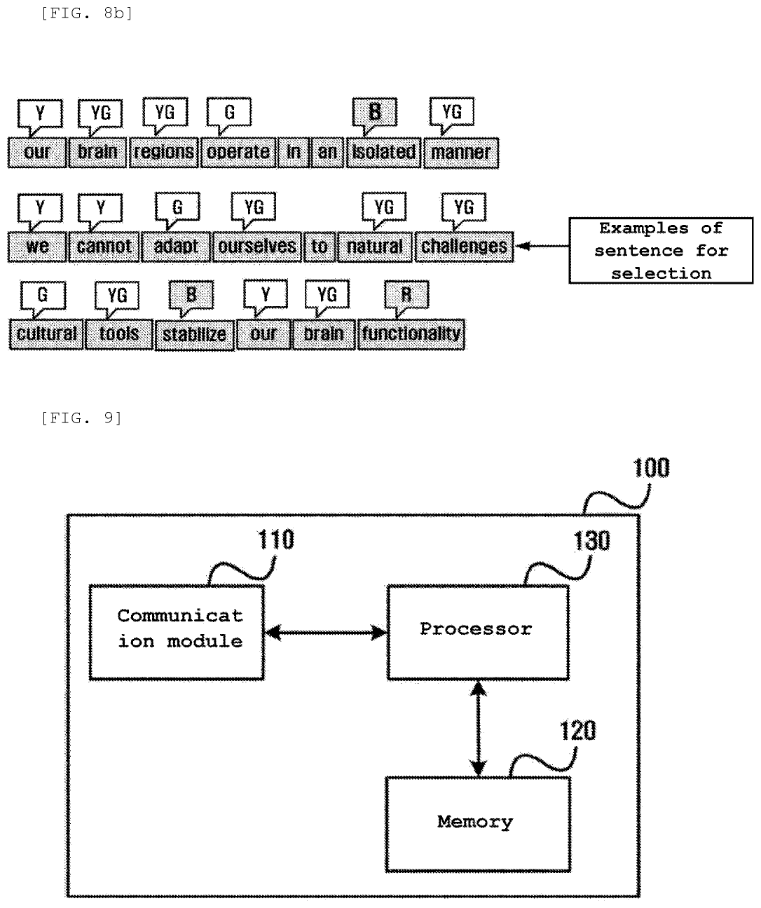

FIGS. 8a and 8b are diagrams illustrating a method of setting a difficulty level in the embodiment of the present invention.

For example, if the difficulty level of vocabulary is divided into 6 levels of Y<YG<G<B<R<P and is graded, the user may designate a desired level of vocabulary according to the user's wish.

Further, the server may generate an incorrect answer choice with vocabulary below the vocabulary level designated by the user.

In other words, when the user selects G grade difficulty, the server may generate an incorrect answer choice using Y, YG and G grade vocabulary. If the highest P grade difficulty is selected, the server may generate an incorrect answer choice without any vocabulary constraints.

In this regard, when predicting a plurality of replaceable words at a position of the masked token based on the probability value, the server may set a difficulty level designated by the user through filtering the frequency of appearance of words exceeding the difficulty level among the plurality of words.

For example, referring to FIG. 8a, in the example of FIG. 4a and followings, that is, with regard to the sentence “He makes me happy and I love him always”, a process of predicting a plurality of replaceable words at the position of the masked token may be performed based on a probability value.

At this time, the server may classify a plurality of words predicted based on a probability value into grades for each difficulty level (“difficulty grade”), and adjust appearance probability of words exceeding the corresponding difficulty grade according to the difficulty grade designated by the user.

In other words, when the user designates G grade difficulty in FIG. 8a, the server may filter the appearance probability of tokens for B, R and P grades having a difficulty level more than grade G. For example, if a filter intensity is set to 100%, tokens for B, R and P grades will not appear. However, if all of the filtered vocabulary do not appear, incorrect answer sentences with somewhat awkward grammar or sentence configuration may be created. Therefore, it is desirable to set a possible appearance level, that is, a filter intensity of 90%. Occasionally, the filter intensity can be freely set depending on the user's actual work.

Such a probability filter may be disposed between the kernel and the sampling process.

In another embodiment, with regard to determination of final incorrect answer candidate choices, the server may determine the final incorrect answer candidate choices based on the frequency of appearance of words that exceed the designated difficulty level among the words included in the incorrect answer candidate choices.

Alternatively, with regard to determination of multiple final incorrect answer choices according to the embodiment, multiple incorrect answer choices may be determined according to the frequency of appearance of words that exceed the designated difficulty level among the words included in final incorrect answer candidate choices.

For example, referring to FIG. 8b, the server counts the number of words for each difficulty grade with regard to the designated range in multiple generated incorrect answer candidate choices, and then may determine the final incorrect answer candidate choices or incorrect answer choices according to the frequency of appearance of words that exceed the designated difficulty grade.

In other words, when the user selects G grade difficulty, the number of words is counted by difficulty grade for the words included in the sentences “our/brain/region/operate/in/an/isolated/manner”, “we/cannot/adapt/ourselves/to/natural/challenges”, and “cultural/tools/stabilize/our/brain/functionality”, which are the final incorrect answer candidate choices. As a result of the counting, the first sentence includes one (1) B grade word (“isolated”) exceeding G grade difficulty while the third sentence includes one (1) B grade word (“stabilize”) and one (1) R grade word (“functionality”), so that the second sentence except for the above first and third sentences can be selected as the final incorrect answer candidate choice.

Meanwhile, it goes without saying that the above examples of FIGS. 8a and 8b may be independently applied in determining the final incorrect answer candidate choice or incorrect answer choice, or these may be combined with each other and applied simultaneously.

In the above description, according to the embodiments of the present invention, steps S110 to S140 may be further divided into additional steps or may be combined into fewer steps. Further, some steps may be omitted as necessary or the order of the steps may be altered. Further, even if other contents are omitted, the contents of FIG. 9 described later may also be applied to the method for automatically creating a foreign language sentient blank inference question shown in FIGS. 2 to 8b.

Hereinafter, a system 100 for automatically creating a foreign language sentence blank inference question according to an embodiment of the present invention will be described with reference to FIG. 9.

FIG. 9 is a diagram illustrating a system 100 for automatically creating a foreign language sentence blank inference question according to an embodiment of the present invention.

Referring to FIG. 9, the system 100 for automatically creating a foreign language sentence blank inference question may include a communication module 110, a memory 120 and a processor 130.

The communication module 110 may receive one or more foreign language sentences inputted by a user. Further, the module may receive a range to be designated as a blank among the input foreign language sentences and setting information for the designated range.

The memory 120 may be stored with a program to create a blank inference question with regard to the foreign language sentences received in the communication module 110.

The processor 130 may execute the program stored in the memory 120. As the program stored in the memory 120 is executed, the processor 130 may create a blank inference question according to the blank range and the setting information through a preset artificial intelligence (AI)-based sentence generation algorithm. A method for creating a blank inference question executed by the processor 130 is as described above.

The system 100 for automatically creating a foreign language sentence blank inference question described with reference to FIG. 9 may be provided as a component of the above-described server.

The method for automatically creating a foreign language sentence blank inference question according to an embodiment of the present invention described above may be implemented as a program (or application) to be executed while being combined with a computer as hardware, followed by being stored in a medium.

The above-described program may include a code (Code) coding in a computer language such as a machine language, C, C++, JAVA, Ruby, etc., which is readable by a processor (CPU) of the computer through a device interface of the computer, so that the computer reads the program and executes the above methods implemented as a program. Such a code may include a functional code related to mathematical functions or the like that define necessary functions for conducting the methods described above, and a control code related to an execution procedure required for the processor of the computer to execute the functions according to a predetermined procedure. Further, the code may further include additional information necessary for the processor of the computer to execute the functions or a memory reference-related code in regard to a region (address number) in the internal or external memory of the computer at which the media should be referred. Further, when the processor of the computer needs to communicate with any other computer or server in a remote location in order to execute the functions, the code may further include communication-related codes to determine, for example, how to communicate with any other computer or server in a remote location using the communication module of the computer, what information or media to transmit or receive during communication, or the like.

The storage medium is not a medium that stores data for a short moment such as a register, cache, memory, etc. but a medium that stores data semi-permanently and is readable by a device. Specifically, examples of the storage medium may include, but are not limited to, ROM, RAM, CD-ROM, magnetic tape, floppy disk, optical data storage device, and the like. That is, the program may be stored in different recording media on various servers to which the computer can access, or on various recording media in the computer of a user. Further, the medium may be distributed throughout a computer system connected through a network, and computer-readable codes may be stored in a distributed manner.

The above description of the present invention is for illustrative purposes only, and those skilled in the art to which the present invention pertains will be able to understand that the present invention may be easily modified into other specific forms without changing the technical spirit or essential features of the present invention. Therefore, it should be understood that the embodiments described above are illustrative in all aspects and are not intended to limit the present invention. For example, each component described as a singular form may be implemented in a distributed manner and, similarly, components described in a distributed manner may also be implemented in a combined form.

The scope of the present invention is specified by the appended claims later rather than the detailed description above, and all changes or modifications derived from the meanings and scope of the claims and their equivalent concepts should be construed as being included in the scope of the present invention.

1. A method for automatically creating a blank inference question for a foreign language sentence (“foreign language sentence blank inference question”), comprising:
inputting one or more foreign language sentences;
designating a range to be set as a blank among the input foreign language sentences;
designating setting information for generation of an incorrect answer choice; and
creating a blank inference question according to the blank range and the setting information using a preset artificial intelligence (AI)-based sentence generation algorithm,
wherein the creation of the blank inference question includes:
setting the designated range as a blank among the input foreign language sentences;
generating the original text in the designated range as a correct answer choice, and
generating multiple incorrect answer choices through the preset AI-based sentence generation algorithm on the basis of the correct answer choice,
wherein the generation of the multiple incorrect answer choices includes:
dividing the input foreign language sentence into word-based tokens;
masking a token randomly selected in the designated range;
predicting a plurality of replaceable words at the masked token position on the basis of a probability value.
sampling the plurality of words and extracting one token based on the probability value; and
generating an incorrect answer candidate choice by inserting a word corresponding to the extracted token into the masked position.

2. The method according to claim 1, wherein the generation of the multiple incorrect answer choices includes,
generating an incorrect answer choice that consists of the number of tokens having a length equal to or different from the designated range; or
generating one or more incorrect answer choices among an incorrect answer choice having a preset range of similarity to the correct answer choice and an incorrect answer choice outside the preset range of similarity to the correct answer choice.

3. The method according to claim 1, wherein the masking step, the prediction step, the extraction step and the step for generation of an incorrect answer candidate choice are repeatedly implemented for all tokens included in the designated range.

4. The method according to claim 1, wherein the generation of the multiple incorrect answer choices further includes,
passing the words through a kernel that forcibly sets a probability value for a word at a predetermined ratio to 0 among a plurality of predicted words,
wherein the step of sampling the plurality of words and extracting one token based on the probability value comprises,
sampling the words that passed through the kernel and extracting one token based on the probability value.

5. The method according to claim 1, wherein the step of masking a token randomly selected in the designated range comprises,
masking some tokens within the designated range.

6. The method according to claim 5, wherein the generation of the multiple incorrect answer choices includes:
masking on the position of a first token connected to the designated range;
masking some tokens within the designated range and, after masking on the position of the first token, estimating a first probability value that indicates a probability of appearance of the original text word at the corresponding position of the first token;
after inserting the word corresponding to the extracted token into the masked position, estimating a second probability value that indicates a probability of appearance of the original text word at the corresponding position of the first token; and
generating the incorrect answer candidate choice based on the first probability value and the second probability value.

7. The method according to claim 6, wherein the generation of the incorrect answer candidate choice based on the first probability value and the second probability value includes:
if the second probability value is less than or equal to the first probability value, adding a masked token between the corresponding positions of the last token and the first token within the designated range;
extracting one token based on the probability value with respect to the masked token at the added position;
after inserting the extracted token into the added position, estimating a third probability value that indicates a probability of appearance of the original text word at the corresponding position of the first token; and
generating the incorrect answer candidate choice based on the first probability value and the second probability value.

8. The method according to claim 6, wherein the generation of the incorrect answer candidate choice based on the first probability value and the second probability value comprises,
if the second probability value exceeds the first probability value, generating a word corresponding to the extracted token, which was inserted into the masked position, as the incorrect answer candidate choice.

9. The method according to claim 1, wherein the generation of the multiple incorrect answer choices includes:
estimating an appearance probability value for each of the multiple incorrect answer candidate choices with respect to replacement of the original text with the tokens;
calculating an average of the estimated appearance probability values; and
removing the incorrect answer candidate choices out of a preset standard deviation range from the calculated average and then determining final incorrect answer candidate choices.

10. The method according to claim 9, wherein the generation of the multiple incorrect answer choices includes:
calculating a hidden state vector for the correct answer choice;
calculating a hidden state vector for the final incorrect answer candidate choices;
calculating a relevance between the hidden state vector for the correct answer choice and the hidden state vector for the final incorrect answer candidate choices; and
selecting the final incorrect answer candidate choices in the order of the lowest calculated relevance as the multiple incorrect answer choices.

11. The method according to claim 10, wherein the hidden state vector is calculated by generating a hidden state vector for each token included in the correct answer choice or the final incorrect answer candidate choices and then averaging the generated hidden state vectors for the tokens.

12. The method according to claim 11, wherein the hidden state vector for each token contains semantic information of each token.

13. The method according to claim 9, wherein the designation of the setting information for generation of incorrect answer choices includes designating a difficulty level by a user,
wherein the determination of the final incorrect answer candidate choices comprises,
determining the final incorrect answer candidate choices based on the frequency of appearance of words exceeding the designated difficulty level included in the incorrect answer candidate choices.

14. The method according to claim 9, wherein the designation of the setting information for generation of the incorrect answer choices includes designating a difficulty level by a user,
wherein the prediction of a plurality of replaceable words at the position of the masked token based on a probability value comprises,
setting the designated difficulty level by filtering the frequency of appearance of words exceeding the difficulty level among the plurality of words.

15. A system for automatically creating a foreign language sentence blank inference question, comprising:
a communication module that receives one or more foreign language sentences inputted by a user and receives setting information for generation of an incorrect answer choice as well as a range to be set as a blank among the input foreign language sentences;
a memory in which a computer program for creating a blank inference question for the foreign language sentences received in the communication module is stored; and
a processor that creates the blank inference question according to the blank range and the setting information using a preset artificial intelligence (AI)-based sentence generation algorithm as the computer program stored in the memory is executed,
wherein the creation of the blank inference question includes: setting the designated range as a blank among the input foreign language sentence; generating the original text in the designated range as a correct answer choice; and generating multiple incorrect answer choices through the preset AI-based sentence generation algorithm on the basis of the correct answer choice, and
wherein the generation of the multiple incorrect answer choices includes: dividing the input foreign language sentence into word-based tokens; masking a token randomly selected in the designated range; predicting a plurality of replaceable words for the masked token position on the basis of a probability value; sampling the plurality of words and extracting one token based on the probability value; and generating an incorrect answer candidate choice by inserting a word corresponding to the extracted token into the masked position.
